(19) United States
(12) Patent Application Publication
(10) Pub. No.: US 2011/0162730 A1
(43) Pub. Date: Jul. 7, 2011

(54) VALVE FOR A PRESSURE REGULATOR

(75) Inventor: Jeffrey Bryan Gotthelf, Summerville, SC (US)

(73) Assignee: ITT Manufacturing Enterprises, Inc., Wilmington, DE (US)

(21) Appl. No.: 12/651,665

(22) Filed: Jan. 4, 2010

(51) Int. Cl. F16K 31/12; G05D 16/00

(52) U.S. Cl. 137/505; 251/366

(57) ABSTRACT

A valve for a fuel pressure regulator includes a shaft defining a longitudinal axis. The shaft has a protuberance defining a mating surface that is positionable against a valve seat of the regulator and a flow surface that intersects the mating surface. A first angle is defined between the mating surface and a plane that is orthogonal to the longitudinal axis of the shaft. A second angle is defined between the flow surface and a plane that is orthogonal to the longitudinal axis. The first angle and the second angle are both oblique with respect to the longitudinal axis of the shaft.

### TECHNICAL FIELD

The present invention relates to a pressure regulator and a valve for a pressure regulator.

### BACKGROUND OF THE INVENTION

A pressure regulator is a valve that controls fluid flow from a high pressure source to a low pressure device. Pressure regulators are utilized for various applications including, but not limited to, facilitating the delivery of gas or liquid to a device such as a natural gas powered vehicle, for example. The general operation of a pressure regulator and its components are described in U.S. Pat. No. 5,381,819 to Gotthelf, which is incorporated by reference in its entirety.

In a pressure regulator having a valve plug and valve seat arrangement, such as the regulator illustrated in U.S. Pat. No. '819, a mating surface of a spring-loaded valve plug cooperates with a valve seat to open and close the pressure regulator. The mating surface of the valve plug mates and seals with the valve seat in a “no-flow” state to prevent flow through the fluid passageway of the pressure regulator. Conversely, in a “full-flow” state, the mating surface of the valve plug is separated from the valve seat to permit maximum flow through the fluid passageway of the pressure regulator.

There is a continuing need to improve the valve plug and valve seat arrangement of pressure regulators in the interests of performance and reliability.

### SUMMARY OF THE INVENTION

According to one exemplary embodiment, a pressure regulator comprises an inlet port, an outlet port, and a fluid passageway defined between the inlet port and the outlet port providing a passage for the flow of fluid between the inlet port and the outlet port. A valve seat is positioned in the fluid passageway. A valve cooperates with the valve seat to control the flow of the fluid through the fluid passageway.

The valve comprises a shaft defining a longitudinal axis. The shaft has a first shaft portion defining a first diameter that is positioned adjacent the inlet port, a second shaft portion defining a second diameter that is positioned adjacent the outlet port, and a protuberance that is between the first shaft portion and the second shaft portion of the valve. The protuberance defines a mating surface that is positionable against the valve seat and a flow surface that intersects the mating surface. A first angle is defined between the mating surface and the longitudinal axis and a second angle is defined between the flow surface and the longitudinal axis. The first angle and the second angle are both oblique with respect to the longitudinal axis of the shaft.

In an open position of the valve, fluid can flow through the inlet port, along the first shaft portion of the valve, across the flow surface of the protuberance of the valve, across the mating surface of the protuberance of the valve, along the second shaft portion of the valve and through the outlet port.

### BRIEF DESCRIPTION OF THE FIGURES

The invention is best understood from the following detailed description when read in connection with the accompanying drawing. Included in the drawing are the following figures:

FIG. 1 depicts a cross-sectional elevation view of an exemplary embodiment of a pressure regulator that is fluidly coupled to receive fuel from a fuel tank;

FIG. 2A depicts a top plan view of the valve plug illustrated in FIG. 1;

FIG. 2B depicts a cross-sectional view of the valve plug of FIG. 2A taken along the lines 2B-2B; and

FIG. 2C depicts a detailed view of the valve plug of FIG. 2B.

### DETAILED DESCRIPTION OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

Referring generally to the figures and according to one aspect of the invention, a pressure regulator 10 comprises an inlet port 11, an outlet port 13, and a fluid passageway 14/15 defined between the inlet port 11 and the outlet port 13 providing a passage for the flow of fluid between the inlet port 11 and the outlet port 13. A valve seat 4 is positioned in the fluid passageway 14/15. A valve or valve plug 2 cooperates with the valve seat 4 to control the flow of the fluid through the fluid passageway 14/15.

The valve 2 comprises a shaft defining a longitudinal axis A. The shaft has a first shaft portion 46 defining a first diameter D3 that is positioned adjacent the inlet port 11, a second shaft portion 48 defining a second diameter D4 that is positioned adjacent the outlet port 13, and a protuberance 50 positioned between the first shaft portion 46 and the second shaft portion 48 of the valve 2.

The protuberance 50 defines a mating surface 5 that is positionable against the valve seat 4 and a flow surface 52 that intersects the mating surface 5. A first angle A1 is defined between the mating surface 5 and a plane that is orthogonal to the longitudinal axis A and a second angle A2 is defined between the flow surface 52 and a plane that is orthogonal to the longitudinal axis A. The first angle A1 and the second angle A2 are both oblique with respect to the longitudinal axis A of the shaft.

In an open position of the valve 2, fluid can flow through the inlet port 11, along the first shaft portion 46 of the valve 2, across the flow surface 52 of the protuberance 50 of the valve 2, across the mating surface 5 of the protuberance 50 of the valve 2, along the second shaft portion 48 of the valve 2 and through the outlet port 13. In a closed position of the valve 2, fluid is prevented from flowing between the inlet port 11 and the outlet port 13.

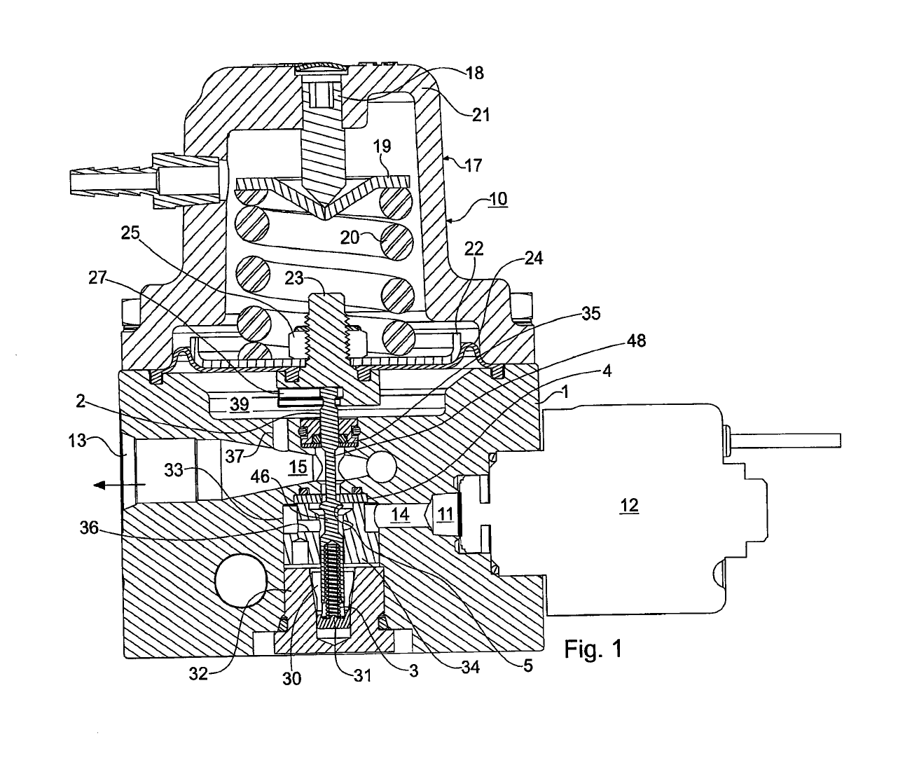

Referring specifically to the exemplary embodiment illustrated in FIG. 1, FIG. 1 depicts a cross-sectional elevation view of an exemplary embodiment of the pressure regulator 10 that is fluidly coupled to receive fuel from a fuel tank 12. Although not explicitly shown, many of the components of the pressure regulator 10 have a cylindrical shape. The pressure regulator 10 facilitates the controlled delivery of fluid from a high pressure source, such as the compressed fuel tank 12, to a device operating at a lower pressure, e.g., a natural gas vehicle engine (not shown).

The pressure regulator 10 comprises a housing or body portion 1 including the inlet port 11 that is fluidly coupled to receive fluid from the fuel tank 12, the outlet port 13 through which fuel is delivered to the low pressure device (not shown) and the flow passage 14/15 disposed between the inlet port 11 and the outlet port 13. The valve plug 2 and the valve seat 4 are positioned in the flow passage 14/15 and cooperate together to control the delivery of fuel or other fluid through the flow passage 14/15 of the regulator 10. The valve plug 2 may also be referred to in the art as a plug, poppett, valve or valve member.

Referring now to the individual components of the regulator 10, the valve plug 2 comprises a cylindrical shaft that includes a top end, a bottom end, and a protuberance 50 defining an annular mating surface 5. The mating surface 5 of the valve plug 2 mates and seals with the annular boundary of an orifice formed in the valve seat 4 to prevent the passage of fuel from fluid passage 14 to fluid passage 15. When the mating surface 5 of the valve plug 2 is separated from the orifice formed in the valve seat 4, fuel or any another fluid is capable of flowing from the upstream fluid passage 14 to the downstream fluid passage 15.

The top end of the valve plug 2 is mounted within a slot 27 formed in a diaphragm insert 23, thereby coupling the valve plug 2 to both the diaphragm insert 23 and a spring-loaded diaphragm 24 that is fastened to the diaphragm insert 23. The top end of the valve plug 2 is slideably positioned within a bore defined in a valve guide 35. The bottom end of the valve plug 2 is slideably positioned in a blind bore of the tapered bushing 30 and a bore defined in a valve seat retainer 34. The tapered bushing 30 and the valve guide 35 are positioned in close proximity to the valve seat 4 for radially stabilizing the valve plug 2 at the valve seat 4. The bushing 30 is physically separated from the fluid passage 14 and the inlet 11 by the valve seat retainer 34.

The spring-loaded diaphragm 24 biases the valve plug 2 in a downward direction against the force of a spring 3. The bottom end of the valve plug 2 includes a blind bore for accommodating the spring 3. One end of the spring 3 is positioned to bear on the terminal end of the bore of the valve plug 2, and the opposite end of the spring 3 is positioned to bear on a terminal end of a blind bore of a tapered bushing 30. The spring 3 biases the valve plug 2 in an upward direction against the force of the spring-loaded diaphragm 24. A protrusion 31 is defined on the terminal end of the bore of the tapered bushing 30 to either limit or prevent lateral movement of the spring 3 within the bore of the bushing 30.

The tapered bushing 30 is accommodated in a tapered bore of a valve cap 32 that is threadedly mounted to a bore 33 defined in the bottom end of the body 1 of the regulator 10. A valve seat retainer 34 is also threadedly mounted to the bore 33 defined in the bottom end of the body 1 of the regulator 10. The top end of the valve seat retainer 34 is positioned to bear on a lower surface of the valve seat 4 to retain the valve seat 4 in a fixed position.

The valve seat 4 includes a central orifice through which the valve plug 2 is slideably positioned. The valve seat retainer 34 includes a fluid flow passage 36 that communicates with the flow passage 14. In an open position of the regulator 10 (not shown), fluid travels from the upstream flow passage 14 through the flow passage 36, through the orifice of the valve seat 4 and into the downstream flow passage 15.

A bonnet assembly 17 is fixedly mounted to the top end of the housing 1 of the regulator 10. The bonnet assembly 17 includes a bell-shaped bonnet 21 and a user-adjustable screw 18 that is rotatably mounted to a hole provided in the top end of the bonnet 21. Rotation of the screw 18 influences the pressure exerted by a range spring 20 on a diaphragm 24. More particularly, the end of the screw 18 is positioned to bear on a top surface of an upper spring retainer plate 19. The upper spring retainer plate 19 is positioned to bear on a range spring 20 which, in turn, is positioned to bear on a lower spring retainer plate 22. The lower spring retainer plate 22 is positioned to bear on a diaphragm 24. The diaphragm 24 is mounted between the lower face of the bonnet 21 and top face of the housing 1 of the regulator 10. The diaphragm 24 is optionally composed of a hydrogenated nitrile rubber material that is particularly suitable for cold temperatures.

A diaphragm insert 23 is fixedly mounted to the diaphragm 24 by a threaded nut 25. The lower end of the diaphragm insert 23 includes a slot 27 through which the top end of the valve plug 2 is received. The spring 20 is positioned to bias the diaphragm 24 in the downward direction, which, in turn, urges the valve plug 2 in the downward direction. Accordingly, the spring 20 biases the mating surface 5 of the valve plug 2 away from the valve seat 4 against the force of spring 3.

An aspirator hole 37 defined in the regulator body 1 fluidly connects the downstream fluid passage 15 with a sensing chamber 39. The sensing chamber 39 is defined between the diaphragm 24 and a bore that is formed on the top end of the housing 1. Stated another way, the diaphragm 24 encapsulates, covers or conceals the sensing chamber 39. The aspirator hole 37 corrects fluid flow droop at low pressures. Further details of aspirator holes and droop correction are disclosed in U.S. Patent Application Publication No. 20060260690 to Winnike et al., which is incorporated by reference herein.

As shown in FIG. 1, a series of o-rings (shown in circular cross-section) are provided at the interface between mating components of the regulator 10. The o-rings are optionally composed of a hydrogenated nitrile rubber material that is particularly suitable for cold temperatures.

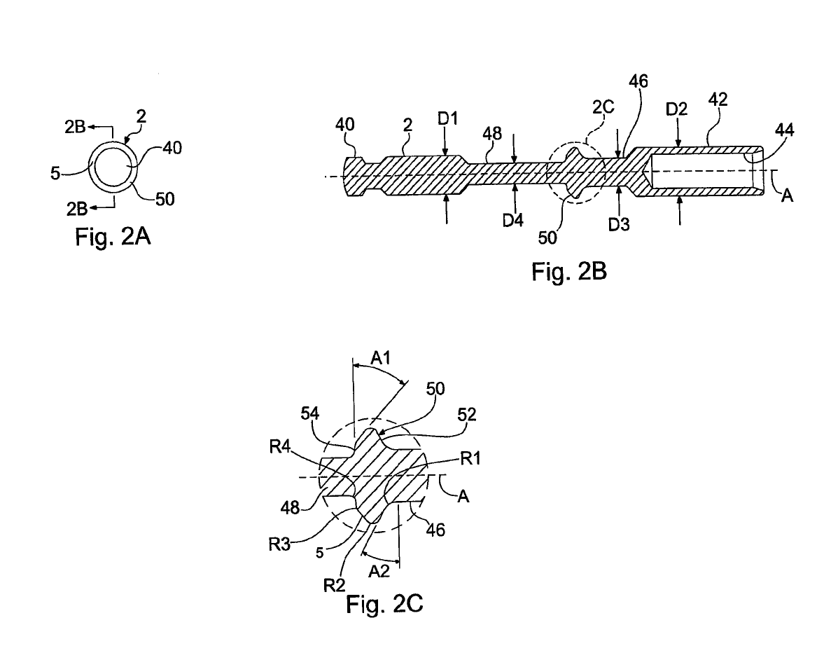

Referring now to FIGS. 2A-2C, FIG. 2B depicts a cross-sectional view of the valve plug 2 of FIG. 2A taken along the lines 2B-2B. The valve plug 2 includes a generally cylindrical shaft extending along a longitudinal axis A. The shaft of the valve plug 2 includes a top end 40 for mating with the slot 27 of the diaphragm insert 23. The top end 40 has a diameter D1 that is slightly smaller than a diameter of the bore of the valve guide 35 in which the first end 40 travels. The bottom end 42 of the valve plug 2 defines a bore 44 for accommodating the spring 3. The bottom end 42 has a diameter D2 that is slightly smaller than a diameter of the bores of the tapered bushing 30 and the valve seat retainer 34 in which the bottom end 42 travels. The diameters D1 and D2 of the valve plug 2 are tailored to achieve radial stability of the valve plug 2, facilitate controlled translation of the valve plug 2 through the respective bores of the valve guide 35, the valve seat retainer 34 and the tapered bushing 30, and minimize vibration of the valve plug 2.

Two reduced-diameter segments 46 and 48, respectively, are defined between the top end 40 and the bottom end 42 of the valve plug. In an assembled form of the regulator 10, the reduced-diameter segment 46 is positioned adjacent to the inlet port 11 and the reduced-diameter segment 48 is positioned adjacent to the outlet port 13. The reduced-diameter segments 46 and 48 may also be referred to herein as first and second shaft portions of the valve plug 2. The reduced-diameter segments 46 and 48 have diameters D3 and D4, respectively. Diameter D3 may be 2.8 millimeters, for example, and diameter D4 may be about 2 millimeters, for example. It should be understood that the diameters D3 and D4 may vary from that shown and described.

Referring back to FIG. 1, an annular passage is defined between reduced-diameter segment 46 and the central bore of the valve seat retainer 34 to permit the passage of fluid from channel 36 toward the downstream segment of the fluid passageway 15. Also, an annular passage is defined between reduced-diameter segment 48 and the orifice of the valve seat 4 to permit the flow of fluid through the orifice of the valve seat 4.

FIG. 2C depicts a detailed view of the protuberance 50 of the valve plug 2 of FIG. 2B. The protuberance 50 is configured to reduce both the turbulence of the flow passing through the fluid passage 14/15 and the pressure drop at low tank pressures. The protuberance 50 may be integral with the shaft, as shown, or, alternatively, the protuberance 50 may be a separate component that is coupled to the shaft. An annular flow surface 52 is defined on one side of the protuberance 50. The annular mating surface 5 is defined on the opposite side of the protuberance 50. A substantially planar surface 54 that is oriented orthogonal to the longitudinal axis A extends between the annular mating surface 5 and the reduced-diameter segment 48. Both of the annular surfaces 5 and 52 are substantially planar, as shown.

An angle A1 is defined between the annular mating surface 5 and a plane that is orthogonal to the longitudinal axis A. An angle A2 is defined between the annular flow surface 52 and a plane that is orthogonal to the longitudinal axis A. Angles A1 and A2 are both oblique (i.e., non-parallel and non-perpendicular) with respect to the longitudinal axis A of the shaft of the valve plug 2. More particularly, and according to one aspect of the invention, angles A1 and A2 about 45 degrees and about 30 degrees, respectively. The annular mating surface 5 and the annular flow surface 52 of the protuberance 50 meet each other at an oblique angle that measures approximately 70 degrees. It should be understood that the aforementioned angles may vary from that shown and described without departing from either the scope or the spirit of the invention.

The surfaces of the protuberance are rounded to reduce both the turbulence of the flow passing through the fluid passage 14/15 and the pressure drop at low tank pressures. More particularly, the reduced-diameter segment 46 intersects the flow surface 52 at a radius R1, which is 0.76 millimeters, for example. The annular mating surface 5 interests the flow surface 52 at a radius R2, which is 0.38 millimeters, for example. The annular mating surface 5 intersects the planar surface 54 at a radius R3, which is 0.76 millimeters, for example. The planar surface 54 intersects the reduced-diameter segment 48 at a radius R4, which is 0.38 millimeters, for example.

Referring now to the operation of the regulator 10, the fuel tank 12 is fluidly connected to the inlet 11 of the regulator 10, such that gas flows through the inlet 11, into the fluid passage 14, and through the channel 36 of the valve seat retainer 34. If the force applied to the diaphragm 24 by the screw 18 is sufficiently greater than the fluid pressure within the upstream flow passage 14 combined with the force applied by the plug spring 3, the diaphragm 24 deflects to translate the valve plug 2 downwards and away from the valve seat 4. As the valve plug 2 translates away from the valve seat 4, the mating surface 5 of the valve plug 2 separates from the valve seat 4 to permit the flow of gas from the upstream fluid passage 14 to the downstream fluid passage 15. More particularly, the gas flows along the reduced-diameter segment 46 of the valve plug 2, around the protuberance 50, along the reduced-diameter segment 48 of the valve plug 2, through the downstream fluid passage 15, and exits through the outlet passage 13.

The fluid passage 15 is tapered to allow the gas to expand gradually. The fluid passage 15 is analogous to a diverging venturi, which reduces static pressure at the aspirator hole 37 which communicates with the sensing chamber 39. The aspirator hole 37 reduces the pressure in the sensing chamber 39 with increasing flow through the fluid passage 15, consequently offsetting pressure drop caused by spring extension above the diaphragm 24 and flow friction. Further details of an aspirator hole and droop correction are disclosed in U.S. Patent Application Publication No. 20060260690 to Winnike et al., which is incorporated by reference herein.

If the fluid pressure within the upstream flow passage 14 combined with the force applied by the plug spring 3 is sufficiently greater than the force applied to the diaphragm 24 by the screw 18, the diaphragm 24 returns to a relaxed position (i.e. straight) and the plug spring 3 expands and urges the valve plug 2 toward the valve seat 4. As the valve plug 2 translates towards the valve seat 4, the mating surface 5 of the valve plug 2 mates and seals with the orifice of the valve seat 4 to prevent the passage of fluid into the downstream fluid passage 15, as illustrated in FIG. 1.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A pressure regulator comprising:
a housing defining an inlet port, an outlet port, and a fluid passageway between said inlet port and said outlet port providing a passage for the flow of fluid between the inlet port and the outlet port;
a valve seat positioned in said fluid passageway; and
a valve cooperating with said valve seat to control the flow of the fluid through the fluid passageway,
wherein the valve comprises a shaft defining a longitudinal axis, said shaft having a first shaft portion that is positioned adjacent the inlet port, a second shaft portion that is positioned adjacent the outlet port, and a protuberance between the first shaft portion and the second shaft portion of the valve, said protuberance defining a mating surface that is positionable against the valve seat and a flow surface that intersects the mating surface,
wherein a first angle is defined between the mating surface of the protuberance and the longitudinal axis and a second angle is defined between the flow surface of the protuberance and the longitudinal axis, wherein the first angle and the second angle are both oriented oblique with respect to the longitudinal axis,
wherein, in an open position of the valve, fluid can flow through the inlet port, along the first shaft portion of the valve, across the flow surface of the protuberance of the valve, across the mating surface of the protuberance of the valve, along the second shaft portion of the valve and through the outlet port.

2. The pressure regulator of claim 1, wherein the first angle differs from the second angle.

3. The pressure regulator of claim 1, wherein the first angle is greater than the second angle.

4. The pressure regulator of claim 1, wherein the first angle measures about 45 degrees.

5. The pressure regulator of claim 1, wherein the second angle measures about 30 degrees.

6. The pressure regulator of claim 1, wherein an end of the valve is slideably positioned within a bushing that is positioned in close proximity to the valve seat.

7. The pressure regulator of claim 1, wherein the flow surface of the protuberance intersects the first shaft portion of the shaft.

8. The pressure regulator of claim 1 further comprising a diaphragm that is coupled to the valve to bias the protuberance away from the valve seat.

9. The pressure regulator of claim 8 wherein the diaphragm is composed of a hydrogenated nitrile rubber material.

10. The pressure regulator of claim 8 further comprising an aspirator defined in the housing of the regulator, said aspirator extending between the outlet port and a sensing chamber that is encapsulated by the diaphragm.

11. A pressure regulator comprising:
a valve including a shaft defining a longitudinal axis, said shaft having a first shaft portion, a second shaft portion and a protuberance between the first shaft portion and the second shaft portion of the valve, said protuberance defining a mating surface that is configured to be positioned against a valve seat and a flow surface that intersects the mating surface,
wherein a first angle is defined between the mating surface of the protuberance and the longitudinal axis and a second angle is defined between the flow surface of the protuberance and the longitudinal axis, wherein the first angle and the second angle are both oblique with respect to the longitudinal axis.

12. The pressure regulator of claim 11, wherein the first angle differs from the second angle.

13. The pressure regulator of claim 11, wherein the first angle is greater than the second angle.

14. The pressure regulator of claim 11, wherein the first angle measures about 45 degrees.

15. The pressure regulator of claim 11, wherein the second angle measures about 30 degrees.

16. The pressure regulator of claim 11, wherein the first shaft portion of the shaft has a larger diameter than the second shaft portion of the shaft.

17. The pressure regulator of claim 11, wherein the flow surface of the protuberance intersects the first shaft portion of the shaft.

18. The pressure regulator of claim 11 further comprising a planar surface extending between the mating surface of the protuberance and the second shaft portion of the shaft.

19. A pressure regulator comprising:
a housing defining an inlet port, an outlet port, and a fluid passageway between said inlet port and said outlet port providing a passage for the flow of fluid between the inlet port and the outlet port;
a valve seat positioned in said fluid passageway;
a valve cooperating with said valve seat to control the flow of the fluid through the fluid passageway, wherein the valve comprises a shaft defining a longitudinal axis, said shaft having a first shaft portion that is positioned adjacent the inlet port, a second shaft portion that is positioned adjacent the outlet port, and a protuberance between the first shaft portion and the second shaft portion of the valve, said protuberance defining a mating surface that is positionable against the valve seat and a flow surface that intersects the mating surface, wherein a first angle is defined between the mating surface of the protuberance and the longitudinal axis and a second angle is defined between the flow surface of the protuberance and the longitudinal axis, wherein the first angle and the second angle are both oriented oblique with respect to the longitudinal axis;
a diaphragm that is coupled to the valve to bias the protuberance away from the valve seat, wherein the diaphragm is composed of a hydrogenated nitrile rubber material;
a bushing, in which an end of the valve plug is slideably positioned, that is positioned in close proximity to the valve seat; and
an aspirator defined in the housing of the regulator, said aspirator extending between the outlet port and a sensing chamber that is encapsulated by the diaphragm,
wherein, in an open position of the valve, fluid can flow through the inlet port, along the first shaft portion of the valve, across the flow surface of the protuberance of the valve, across the mating surface of the protuberance of the valve, along the second shaft portion of the valve and through the outlet port.
